(19) United States
(12) Patent Application Publication
(10) Pub. No.: US 2019/0012982 A1
(43) Pub. Date: Jan. 10, 2019

(54) SIGNAGE TERMINAL, SIGNAGE SYSTEM, AND CONTENT REPRODUCTION METHOD

(71) Applicant: PANASONIC INTELLECTUAL PROPERTY MANAGEMENT CO., LTD., Osaka (JP)

(72) Inventors: Hiroki SINOHARA, Kanagawa (JP); Koichiro YAMAGUCHI, Osaka (JP)

(73) Assignee: PANASONIC INTELLECTUAL PROPERTY MANAGEMENT CO., LTD., Osaka (JP)

(21) Appl. No.: 16/082,434

(22) PCT Filed: Feb. 21, 2017
(86) PCT No.: PCT/JP2017/006264

§ 371 Date: Sep. 5, 2018

(30) Foreign Application Priority Data
Mar. 11, 2016 (JP) 2016-048533

(51) Int. Cl. G09G 5/00; G09G 5/393; G09G 5/395; H04L 29/08

(52) U.S. Cl. CPC G09G 5/006; G09G 5/393; G09G 5/395; H04L 67/1097; G09G 3/36; G09G 2370/025; G09G 2380/06; G09G 2330/08; G09G 2370/022

(57) ABSTRACT

In a case where download of signage content from the signage server to a signage terminal fails or delays, avoiding blackout in the signage terminal is possible. Signage terminal is configured to include receiver that downloads signage content from signage server based on a prescribed download instruction, a content storage that stores up the signage content that is downloaded in receiver, and a content display unit that determines whether the download of the signage content in the receiver succeeds or fails, that reproduces and displays the signage content that is stored up in the content storage, according to a reproduction schedule for the signage content, in a case where it is determined that the download succeeds, and that displays a substitute content which is determined in advance, instead of the signage content of which the download fails, in a case where it is determined that the download fails.

### TECHNICAL FIELD

The present disclosure relates to a signage terminal that reproduces and displays signage content which is downloaded from a signage server, a signage system that includes the signage terminal, and a content reproduction method in the signage terminal.

### BACKGROUND ART

In recent years, digital signage technologies have been widely used that takes out an advertisement by delivering and reproducing signage content such as a commercial image to a display device, such as a liquid crystal display device, which is installed event facilities, such as a soccer stadium, a baseball stadium, and a concert hall, commercial facilities, such as a shopping center, a hotel, a movie theater, and an amusement park, public transportation facilities, such as a station and an airport, and the like. The digital signage technology has an advantage in that because signage content is delivered with download delivery or streaming delivery via a network, a change of content can be made in a quick and easy manner. Furthermore, accordingly, the digital signage technology also has an advantage in that advertising can be performed in a more effective or efficient manner when compared with the case of television CM, an advertisement poster, an advertising board, or the like.

Regarding the digital signage technology, a technology is known that displays live information (for example, a live image that is captured with a camera which is installed in a live concert hall), instead of the signage content at a time that is determined in advance (refer to PTL 1). The technology that is disclosed in PTL 1 sets in advance a reproduction starting time and a reproduction ending time for live information, and thus can display, in any switching manner, not only advertisement content that is delivered, but also live information.

### CITATION LIST

### Patent Literature

PTL 1: Japanese Patent Unexamined Publication No. 2010-045633

### SUMMARY OF THE INVENTION

However, a problem with the digital signage technology in the related art is that, in a case where the download of the signage content from the signage server to the signage terminal fails or delays due to network traffic (congestion) or the like, the signage content cannot be reproduced in the signage terminal according to a reproduction schedule which defines the reproduction starting time and the reproduction ending time. In such a case, because the signage content is not reproduced even at the reproduction starting time, a phenomenon called blackout, in which a display screen of the signage terminal appears in coal-black occurs. For this reason, in the case where the download of the signage content fails or delays, in order to avoid the blackout, it is desirable that any substitute content is displayed instead of the signage content of which the download fails or delays.

The digital signage technology in the related art, which is disclosed in PTL 1, can display, in any switching manner, not only the signage content that is delivered, but also the live information. However, because there is a need to set in advance the time at which switching from the displaying of the signage content to the displaying of the live information is performed, in a case where the download of the signage content from the signage server fails or delays, the substitute content cannot be displayed instead of the live information.

A main object of the present disclosure, which is provided in view of the problem in the related art, is to provide a signage terminal, a signage system and a content reproduction method, all of which are capable of avoiding blackout in the signage terminal in a case where download of signage content from a signage server to the signage terminal fails or delays.

According to the present disclosure, there is provided a signage terminal reproduces and displays signage content that is downloaded from a signage server, the terminal including: a receiver that downloads the signage content from the signage server based on a prescribed download instruction; a content storage that stores up the signage content which is downloaded in the receiver; and a content display unit that determines whether the download of the signage content in the receiver succeeds or fails, that reproduces and displays the signage content that is stored up in the content storage, according to a reproduction schedule for the signage content, in a case where it is determined that the download succeeds, and that displays a substitute content which is determined in advance, in a case where it is determined that the download fails.

According to the present disclosure, in a case where download of signage content from the signage server to a signage terminal fails or delays, it is possible that blackout in the signage terminal is avoided.

### BRIEF DESCRIPTION OF DRAWINGS

FIG. 1A is a schematic configurational diagram of a signage system according to a first embodiment of the present disclosure.

FIG. 1B is a diagram illustrating an application example of the signage system.

FIG. 2 is a functional block diagram of the signage system.

FIG. 3 is a functional block diagram of main portions of a signage terminal that is included in the signage system in FIG. 2.

FIG. 4 is a diagram illustrating an example of data file of signage content.

FIG. 5A is a diagram illustrating an example of content data of the signage content.

FIG. 5B is a diagram illustrating an example of playlist information and schedule information.

FIG. 6 is a diagram illustrating a status of the signage terminal.

FIG. 7 is a block diagram illustrating a flow for processing by a signage terminal according to the first embodiment.

FIG. 8A is diagram illustrating an example of content data of default content.

FIG. 8B is a diagram illustrating an example of default playlist information and default schedule information.

FIG. 9 is a block diagram illustrating a flow for processing by a signage terminal according to a second embodiment.

FIG. 10A is a diagram illustrating an example of content data of reproduction-completed signage content.

FIG. 10B is a diagram illustrating the default playlist information and the default schedule information.

FIG. 11 is a block diagram illustrating a flow for processing by a signage terminal according to a third embodiment.

FIG. 12 is a block diagram illustrating a flow for processing that determines whether download in a signage terminal according to a fourth embodiment succeeds or fails.

### DESCRIPTION OF EMBODIMENTS

According to a first disclosure that is provided to solve the problems described above, there is provided a signage terminal that reproduces and displays signage content that is downloaded from a signage server, based on a prescribed download instruction, the terminal including: a receiver that downloads the signage content from the signage server; a content storage that stores up the signage content which is downloaded in the receiver; and a content display unit that determines whether the download of the signage content in the receiver succeeds or fails, and that reproduces and displays the signage content which is stored up in the content storage, according to a reproduction schedule for the signage content, in a case where it is determined that the download succeeds, and displays a substitute content which is determined in advance, in a case where it is determined that the download fails.

With the signage terminal according to the first disclosure, the substitute content can be displayed instead of the signage content of which the download fails, in the case where the download of the signage content from the signage server fails. Accordingly, it is possible that blackout in the server terminal at the time of the download failure is avoided.

Furthermore, a second disclosure is that in the signage terminal according to the first disclosure, in a case where the download is not completed by a reproduction starting time that is defined in the reproduction schedule, it is determined that the download fails.

With the signage terminal according to the second disclosure, it can also be determined that the download fails, in a case where the download of the signage content from the signage server delays. Accordingly, in a case where the download delays, the substitute content is displayed instead of the signage content of which the download delays, and thus it is possible that the blackout in the signage terminal is avoided.

Furthermore, a third disclosure is that in the signage terminal according to the first disclosure or the second disclosure, the substitute content is an image that is provided from an image providing server that is determined in advance.

With the signage terminal according to the third disclosure, an image can be easily provided as the substitute content, in a case where the download of the signage content from the signage server fails or delays.

Furthermore, a fourth disclosure is that in the signage terminal according to the first disclosure or the second disclosure, the substitute content is a default content that is stored up in advance in the content storage.

With the signage terminal according to the fourth disclosure, the default content can be easily provided as the substitute content, in a case where the download of the signage content from the signage server fails or delays. Furthermore, a fifth disclosure is that in the signage terminal according to the fourth disclosure, the default content is reproduction-completed signage content that is stored up in the content storage.

With the signage terminal according to the fifth disclosure, because the reproduction-completed signage content can be used as the default content, there is no need to store up the default content in advance in the content storage.

Furthermore, a sixth disclosure is that in the signage terminal according to the fifth disclosure, use and non-use determination information that defines whether or not the signage content is used as the default content is assigned to the signage content, and referring to the use and non-use determination information, the signage content that is defined as being available for use as the default content is used as the default content.

With the signage terminal according to the sixth disclosure, because the signage content that is defined as being available for use as the default content is used as the default content, it is possible that only suitable signage content that is determined in advance is used as the substitute content. Accordingly, there is no concern that unsuitable signage content will be used as the default content.

Furthermore, according to a seventh disclosure, there is provided a signage system including the signage terminal according to any one of the first disclosure to the sixth disclosure, and a signage server that download-delivers the signage content to the signage terminal.

According to an eighth disclosure, there is provided a content reproduction method that reproduces and displays signage content that is downloaded from a signage server, in a signage terminal, based on a prescribed download instruction, the method including: a reception step of downloading the signage content from the signage server; a content storing-up step of storing up the signage content; and a content display step of determining whether the download of the signage content in the reception step succeeds or fails, and of reproducing and displaying the signage content that is stored up in the content storing-up step, according to a reproduction schedule for the signage content, in a case where it is determined that the download succeeds, and displaying a substitute content which is determined in advance, instead of the signage content of which the download fails, in a case where it is determined that the download fails.

Embodiments of the present disclosure will be described below with reference to the drawings.

### First Embodiment

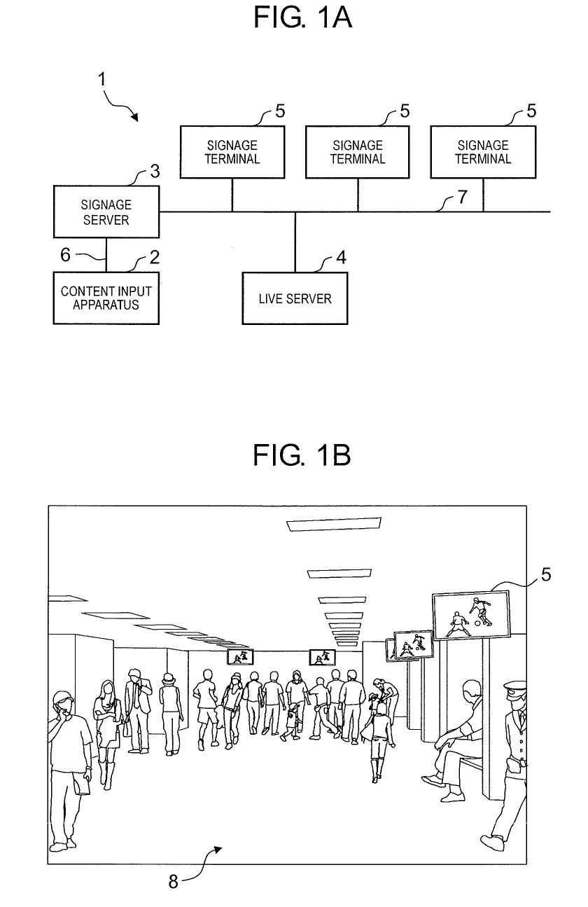

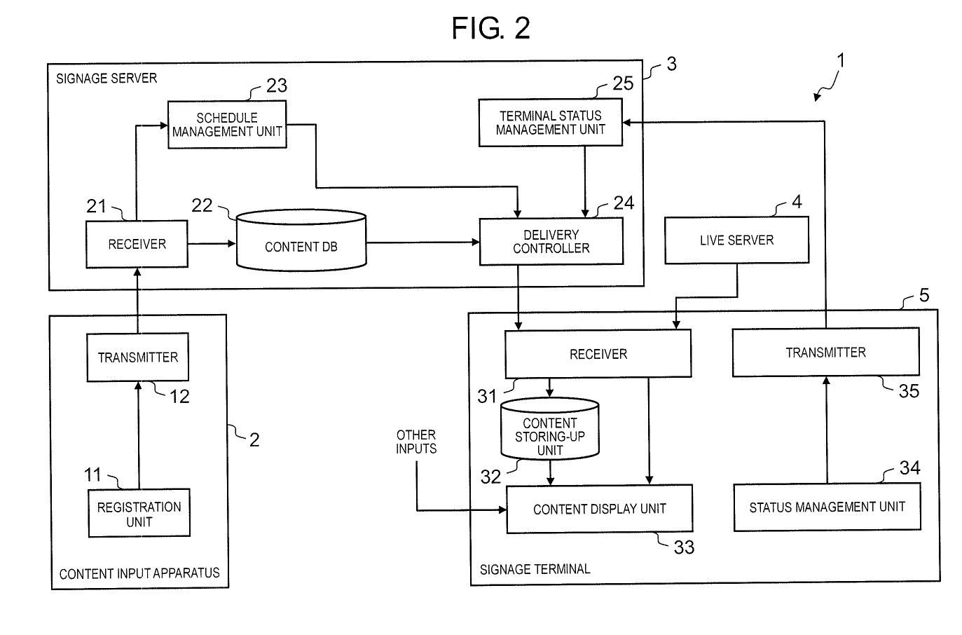

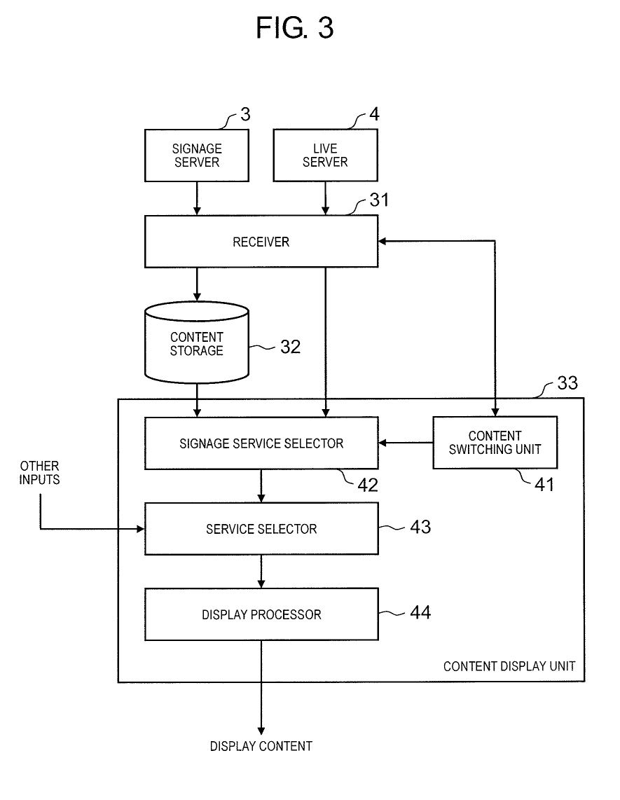

A signage system according to a first embodiment of the present disclosure will be described with reference to FIGS. 1A to 7. FIG. 1A is a schematic configurational diagram of the signage system according to a first embodiment of the present disclosure. FIG. 1B is a diagram illustrating an application example of the signage system. FIG. 2 is a functional block diagram of the signage system. FIG. 3 is a functional block diagram of main portions of the signage terminal that is included in the signage system in FIG. 2.

Signage system 1 is a system for download-delivering signage content from signage server 3 to signage terminal 5 and reproducing and displaying the signage content in signage terminal 5, and, as illustrated in FIG. 1A, includes content input apparatus 2, signage server 3, live server 4, and signage terminal 5. In an example in FIG. 1A, three signage terminals 5 are illustrated, but the number of signage terminals 5 is not particularly limited. Signage server 3 is connected to content input apparatus 2 via network 6, such as the Internet or a Local Area Network (LAN), in a manner that possibly communicates with each other. However, no limitation to this is imposed, and a configuration may be employed in which a direct connection is made in a manner that possibly performs communication through a well-known communication cable. Furthermore, signage terminal 5 is connected to signage server 3 and live server 4 via network 7, such as the Internet or a Local Area Network (LAN), in a manner that possibly performs communication. However, no limitation to this is imposed, and a configuration may be employed in which a direct connection is made in a manner that possibly performs communication through a well-known communication cable.

Signage system 1, for example, possibly finds application in event facilities, such as a soccer stadium, a baseball stadium, and a concert hall, commercial facilities, such as a shopping center, a hotel, a movie theater, and an amusement park, public transportation facilities, such as a station and an airport, and the like. A case will be described below where signage system 1 finds application in the soccer stadium. In the present embodiment, signage terminal 5, as illustrated in FIG. 1B, is installed on a pillar or a wall in a space 8 in the soccer stadium building, and at a prescribed timing, switches between displaying live images of a soccer game and the signage content. The setting of time for switching between the live image and the signage content may be performed manually by a user, and may be performed automatically according to a schedule that is determined in advance. In an example in FIG. 1B, five signage terminals 5 are installed at suitable places in the space 8 in the soccer stadium building. The installation positions of signage terminals 5 and the number of installed signage terminals 5 are not particularly limited.

The apparatuses, content input apparatus 2, signage server 3, live server 4, and signage terminal 5 that constitute signage system 1 will be described with reference to FIGS. 2 and 3. In FIG. 2, illustrations of networks 6 and 7 that are illustrated in FIG. 1A are omitted in FIG. 2. Furthermore, in the present embodiment, it is assumed that the signage content is a moving image. However, the signage content is not limited to the moving image, and may be a still image, audio, or the like.

Content input apparatus 2 is an apparatus for inputting the signage content into signage server 3, and includes registration unit 11 in which a data file including the signage content and information (hereinafter referred to as “delivery schedule information) that defines a reproduction schedule for the signage content and a reproduction terminal is registered or is updated, and transmitter 12 that transmits the data file which is registered in registration unit 11 or is updated, to signage server 3.

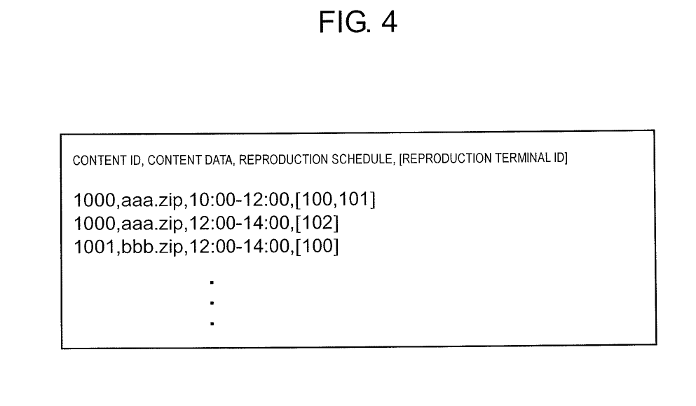

FIG. 4 is a diagram illustrating an example of the data file of the signage content. As illustrated in FIG. 4, the data file of the signage content includes a content ID (for example, “1000”) of the signage content, content data (for example, “aaa.zip”) on the signage content, a reproduction schedule (for example, “10:00 to 12:00”) for the content, and a reproduction terminal ID (for example, “100,” or “101”) for the content. Because the signage content is download-delivered to a plurality of signage terminals 5, a plurality of reproduction terminals ID can be obtained.

Signage server 3 includes receiver 21 that receives data file (refer to FIG. 4) of the signage content that is transmitted from content input apparatus 2, content database (DB) 22 in which the data file is received by receiver 21 is stored, schedule management unit 23 that stores and manages the delivery schedule information which is included in the data file that is received by receiver 21, delivery controller 24 that download-delivers the signage content (the content data, the reproduction schedule, and the like) that is stored in content database (DB) 22, to signage terminal 5 based on the delivery schedule information that is stored in schedule management unit 23, and terminal status management unit 25 that receives terminal status information on signage terminal 5 from signage terminal 5, and stores the received terminal status information.

Live server 4 is an image provision server that provides a live image that results from image-capturing a scene of a soccer game with a camera that is installed at a suitable place in the soccer stadium, to signage terminal 5 via network 7. The installation positions of the camera and the number of installed cameras are not particularly limited. In the present embodiment, it is assumed that an image of the soccer game that is image-captured by switching between a plurality of cameras is transmitted as a live image to signage terminal 5.

Signage terminal 5 includes receiver 31, content storage 32, content display unit 33, status management unit 34, and transmitter 35. It is possible that signage terminal 5, for example, is configured with a set-top box that performs the data communication with signage server 3, and a display device on which the content that is output from the set-top box is displayed.

Based on a prescribed download instruction, receiver 31 downloads (receives) the signage content (the content data, the reproduction schedule, and the like) from signage server 3. It is assumed that the download instruction is obtained in advance by the download from signage server 3, or the like. A result (the signage content) of the download by receiver 31 is input into content storage 32, and content switching unit 41 of content display unit 33 that will be described below. Furthermore, in a case where, in signage service selector 42 that will be described below, the live image is selected as a signage service, receiver 31 receives the live image from live server 4 and inputs the received live image into content display unit 33.

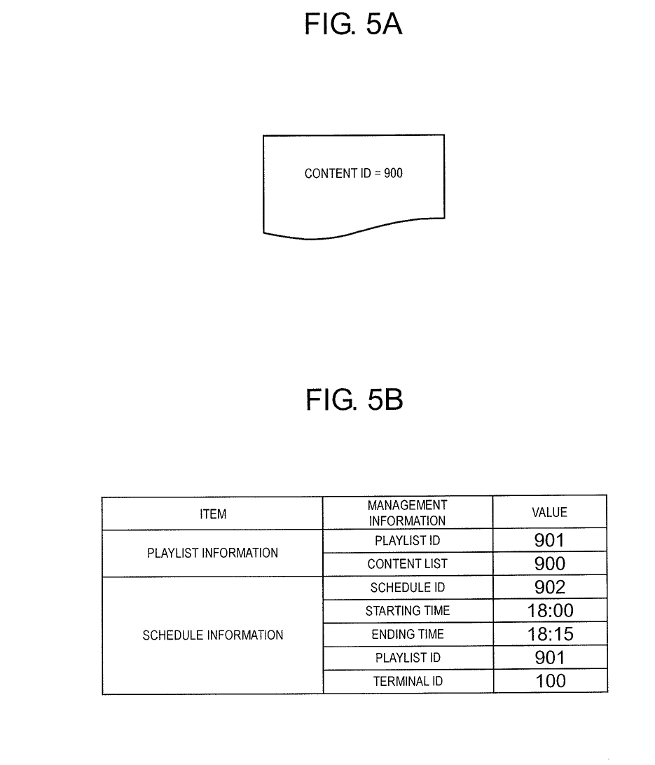

The signage content that is input from receiver 31 is stored up (stored) in content storage 32. FIGS. 5A and 5B are diagrams, each illustrating an example of the signage content. FIG. 5A is an example of the content data of the signage content. FIG. 5B is an example of the playlist information and the schedule information that is the reproduction schedule for the signage content.

As illustrated in FIG. 5A, content ID for uniquely identifying the content data is affixed to the content data of the signage content. In an example in FIG. 5A, “900” is affixed as the content ID. In the example in FIG. 5A, there is one piece of content data, but there may be a plurality of pieces of content data. In such a case, an individual content ID is affixed to each of the pieces of content data.

As illustrated in FIG. 5B, the playlist information includes a playlist ID and a content list. The playlist ID is an identifier for uniquely identifying the playlist information. “901” is affixed as the playlist ID in an example in FIG. 5B. The content list is a list indicating the order of reproduction of the content data. Content IDs are arranged in the order of reproduction in the content list. In the example in FIG. 5B, because there is one piece of content data, the content ID, “900” is contained in the content list.

The schedule information includes a schedule ID, a starting time, an ending time, a playlist ID, and a terminal ID. The schedule ID is an identifier for uniquely identifying the schedule information. In the example in FIG. 5B, “902” is affixed as the schedule ID. The starting time and the ending time are the reproduction schedule for the content data. The starting time and the ending time define a reproduction starting time for the content data and a reproduction ending time for the content data, respectively. In the example in FIG. 5B, the starting time and the ending time are defined as “18:00” and “18:15,” respectively. The playlist ID is a playlist ID of the playlist information that is associated with the schedule information. The terminal ID is a terminal ID of signage terminal 5 that is associated with the schedule information. In the example in FIG. 5B, “901” and “100” are contained in the playlist ID and the terminal ID, respectively.

Content display unit 33 reproduces the signage content (the content data) that is stored up in content storage 32, using playlist information and schedule information. Content display unit 33, as illustrated in FIG. 3, includes content switching unit 41, signage service selector 42, service selector 43, and display processor 44.

Content switching unit 41 acquires the result of the download from receiver 31 (the signage content), and, based on the result of the download, determines whether the download succeeds or fails. In a case where the signage content is normally downloaded, it is determined that the download succeeds. In a case where the signage content is not normally downloaded, it is determined that the download fails. Furthermore, in a case where writing of the signage content fails due to an apparatus malfunction or the like on the signage terminal 5 side, it is also determined that the download fails. In a case where it is determined that the download succeeds, the signage service selector 42 is instructed to select the signage content that is stored up in content storage 32, as the signage service (a service that is possibly provided by signage terminal 5). On the other hand, in a case where it is determined that the download fails, the signage service selector 42 is instructed to select the live image as the signage service.

The signage service selector 42 selects the signage service based on an instruction from content switching unit 41. The signage service is a service that is possibly provided by signage terminal 5, and either “live” that is a service for proving the live image, or “signage” that is a service for providing the signage content is selected. In a case where “live” is selected as the signage service, signage service selector 42 acquires the live image from live server 4 via receiver 31.

In service selector 43, a service that is displayed in signage terminal 5 is selected. Normally, the signage service that is selected in signage service selector 42 is selected as a service that is to be displayed on signage terminal 5, but in a case where the user designates a service other than the signage service, the service (other services) that is designated by the user is selected as a service that is to be displayed on signage terminal 5. Accordingly, for example, it is possible that, in signage terminal 5 that is installed in a VIP room in the soccer stadium, an image service via TV, CATV, or the like, presentation materials, and the like, are displayed. The designation of the service by the user, that is, switching from the signage service to other services, for example, can be performed by switching between HDMI (a registered trademark) input terminals (switching to “other inputs”).

Display processor 44 is a display device, for example, such as a liquid crystal display, and outputs and displays the service that is selected in service selector 43. Display processor 44 is not limited to the liquid crystal display, and may be any other display device, such as a plasma display, that can output and display the service which is selected in service selector 43.

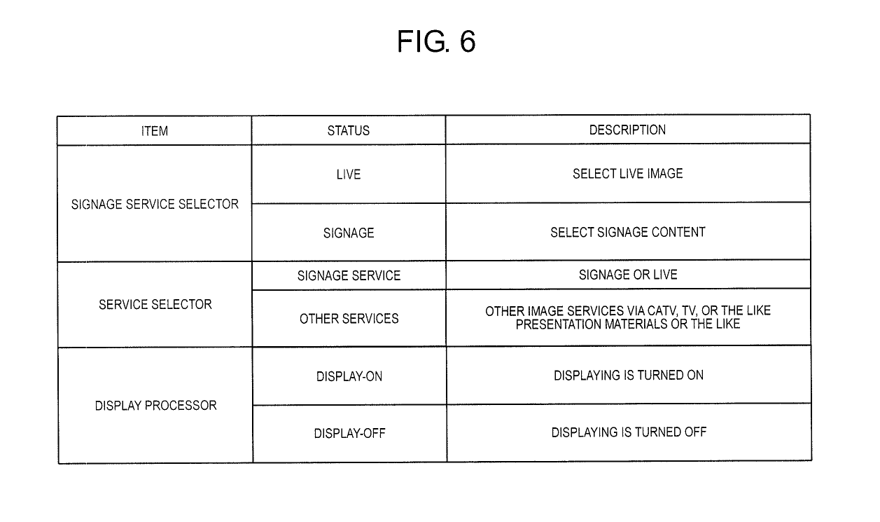

Status management unit 34 manages the terminal status indicating the status of signage terminal 5. FIG. 6 is a diagram illustrating the status of signage terminal 5. As illustrated in FIG. 6, statuses of signage terminal 5 include a status (live or signage) of the signage service that is selected in signage service selector 42, and a status (a signage service or other services) of a service that is selected in service selector 43, and an ON/OFF status (display-ON or display-OFF) of display processor 44. Furthermore, status management unit 34 adds a terminal ID of signage terminal 5 to the terminal status described above, and thus creates the status notification data.

Transmitter 35 periodically transmits the status notification data that is created in status management unit 34, to terminal status management unit 25 of signage server 3. Accordingly, it is possible that signage server 3 manages of the status of signage terminal 5. The creating of the status notification data may be performed in transmitter 35 instead of status management unit 34.

Although not illustrated in detail, each of the constituent apparatuses (content input apparatus 2, signage server 3, live server 4, and signage terminal 5) of signage system 1 has a hardware configuration that includes a Central Processing Unit (CPU) that, in a centralized manner, performs various pieces of information processing operations that is based on a prescribed control program, executes control or the like of peripheral devices, and so forth, a Random Access Memory (RAM) that functions as a working area for the CPU, or the like, a Read Only Memory (ROM) in which a control program that is executed by the CPU, or data is stored, a network interface that performs communication processing via a network, a monitor (an image output device), a speaker, an input device, a hard disk drive (HDD) and the like. It is possible that at least one or several of the functions of the unit of each of the constituent apparatus are realized by the CPU executing a prescribed control program. At least one or several of the functions of each constituent apparatus may be replaced with processing by other well-known hardware.

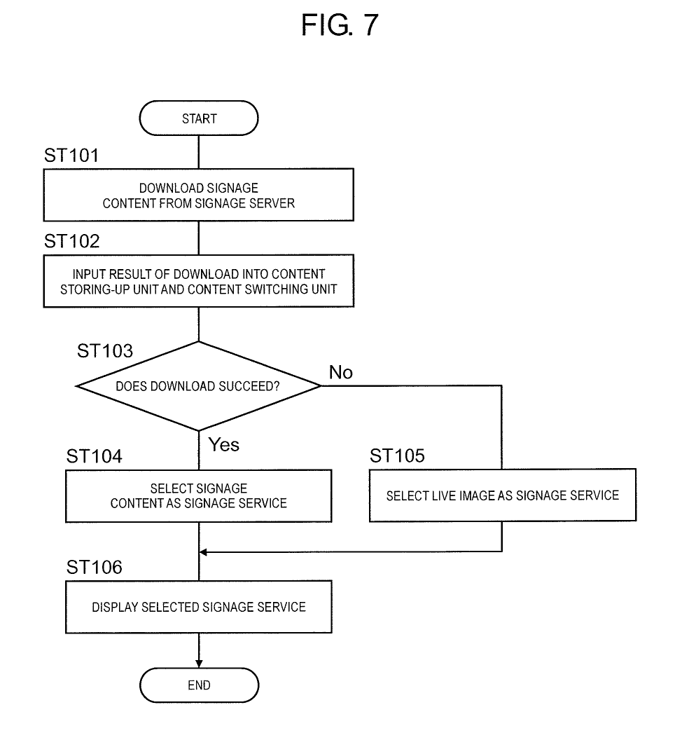

Next, a flow for processing by signage terminal 5 according to the first embodiment will be described with reference to a flow in FIG. 7.

First, based on a prescribed download instruction, receiver 31 downloads the signage content from signage server 3 (ST101). A result (the signage content) of the download by receiver 31 is input into content storage 32 and content switching unit 41 (ST102). Next, based on the result of the download, content switching unit 41 determines whether the download succeeds or fails in receiver 31 (ST103). In a case where the signage content is normally downloaded, it is determined that the download succeeds. In a case where the signage content is not normally downloaded, it is determined that the download fails. Furthermore, in a case where writing of the signage content fails due to an apparatus malfunction or the like on the signage terminal 5 side, it is also determined that the download fails. In a case where it is determined that the download succeeds (Yes in ST103), proceeding to Step ST104 takes place. In a case where it is determined that the download fails (No in ST103), proceeding to Step ST105 takes place.

In Step ST104, content switching unit 41 instructs the signage service selector 42 to select the signage content that is stored up in content storage 32, as the signage service. In Step ST105, content switching unit 41 instructs the signage service selector 42 to select the live image as the signage service. In Step ST106, the display processor 44 displays the signage service that is selected in the signage service selector 42.

In signage terminal 5, each time the signage content is downloaded from signage server 3, Steps ST101 to ST106, which are described above, are repeatedly performed. In a case where the user selects a service other than the signage service, the display processor 44 displays the service that is selected by the user.

With signage terminal 5 according to the first embodiment of the present disclosure, which is configured as described above, in a case where the download of the signage content from signage server 3 fails, because instead of the signage content of which the download fails, the live image that is acquired from live server 4 is displayed as the substitute content, it is possible that the blackout in signage terminal 5 at the time of the failure of the download is avoided.

### Second Embodiment

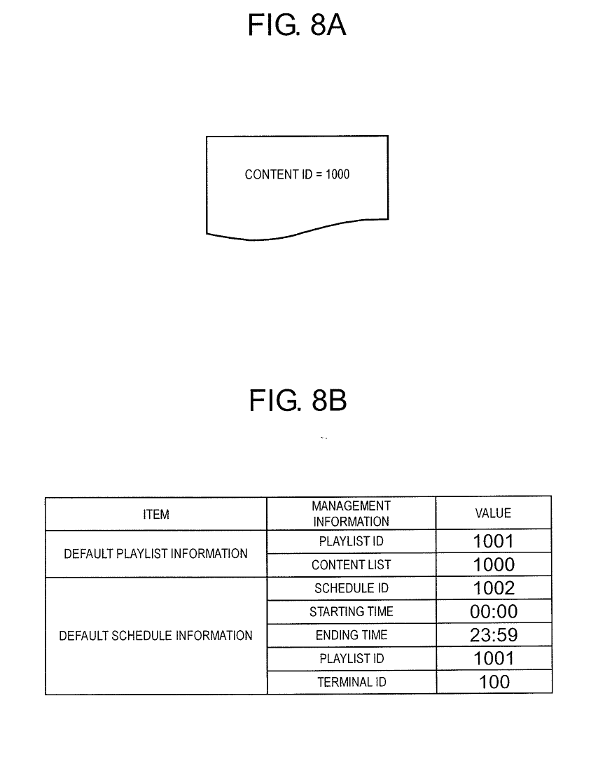

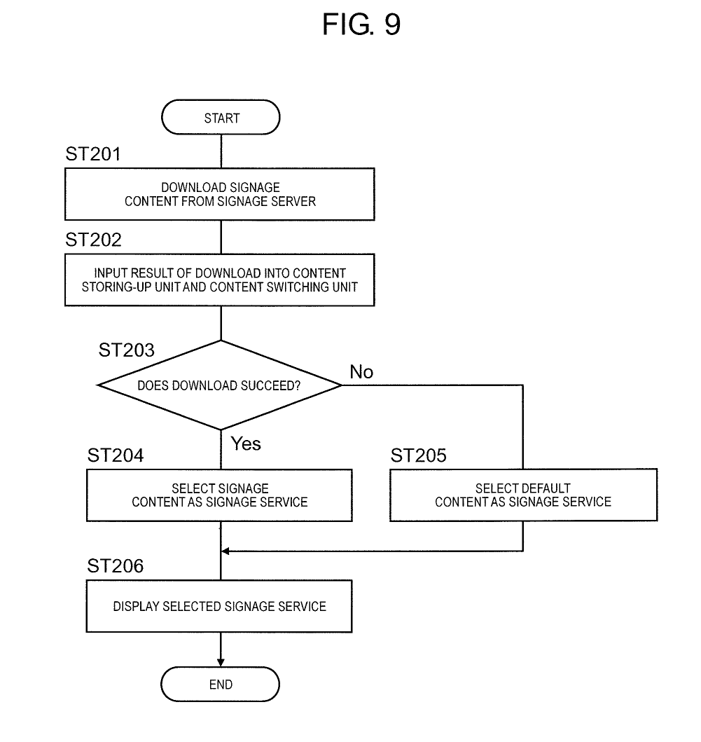

Next, signage terminal 5 according to a second embodiment of the present disclosure will be described with reference to FIGS. 8A, 8B, and 9. Signage terminal 5 according to the second embodiment is different from that according the first embodiment in that the default content that is stored up (stored) in advance in content storage 32 is used as the substitute instead of the live image, not using a live image. In the second embodiment, it is assumed that matters that will be not particularly described below is the same as those in the first embodiment.

The default content is content that is retained in advance by signage terminal 5, and is stored up in content storage 32. In the present embodiment, the default content is a moving image. The default content is not limited to the moving image, and may be a still image, audio, or the like. Furthermore, content switching unit 41 retains default playlist information and default schedule information for reproducing the default content. FIGS. 8A and 8B are diagrams, each illustrating example of the default content. FIG. 8A illustrates an example of the content data of the default content. FIG. 8B illustrates an example of the default playlist information and the default schedule information that are the reproduction schedule.

As illustrated in FIG. 8A, content ID for uniquely identifying the default content data is affixed to the content data of the default content. In an example in FIG. 8A, “1000” is affixed as the content ID. In the example in FIG. 8A, there is one piece of content data, but there may be a plurality of pieces of content data. In such a case, an individual content ID is affixed to each of the pieces of content data.

As illustrated in FIG. 8B, the default playlist information includes a playlist ID and a content list. The playlist ID is an identifier for uniquely identifying the default playlist information. “1001” is affixed as the playlist ID in the example in FIG. 8B. The content list is a list indicating the order of reproduction of the content data. Content IDs are arranged in the order of reproduction in the content list. In the example in FIG. 8B, because there is one piece of content data, the content ID, “1000” is contained.

The default schedule information includes a schedule ID, a starting time, an ending time, a playlist ID, and a terminal ID. The schedule ID is an identifier for uniquely identifying the default schedule information. In the example in FIG. 8B, “1002” is affixed as the schedule ID. The starting time and the ending time are the reproduction schedule for the content data. The starting time and the ending time define a reproduction starting time for the content data and a reproduction ending time for the content data, respectively. In the example in FIG. 8B, the starting time and the ending time are defined as “00:00” and “23:59,” respectively. That is, it is possible that the default content is reproduced at all time. The play list ID is a playlist ID of the default playlist information that is associated with the default schedule information. The terminal ID is an ID of signage terminal 5 that is associated with the default schedule information. In the example in FIG. 8B, “1001” and “100” are contained in the playlist ID and the terminal ID, respectively.

Next, a flow for processing by signage terminal 5 according to the second embodiment will be described with reference to a flow in FIG. 9.

ST201 to ST204 are the same as ST101 to ST104 according to the first embodiment, which are described above, and thus descriptions thereof are omitted. In Step ST205 that follows ST204, content switching unit 41 but only passes the default playlist information and default service information on to signage service selector 42, but also instructs signage service selector 42 to select the default content that is stored up in advance in content storage 32, as the signage service. In Step ST206, display processor 44 displays the signage service that is selected in signage service selector 42.

With signage terminal 5 according to the second embodiment of the present disclosure, which is configured as described above, in the case where the download of the signage content from signage server 3 fails, because instead of the signage content of which the download fails, the default content that is stored up in advance in content storage 32 is displayed as the substitute content, it is possible that the blackout in signage terminal 5 at the time of the failure of the download is avoided.

### Third Embodiment

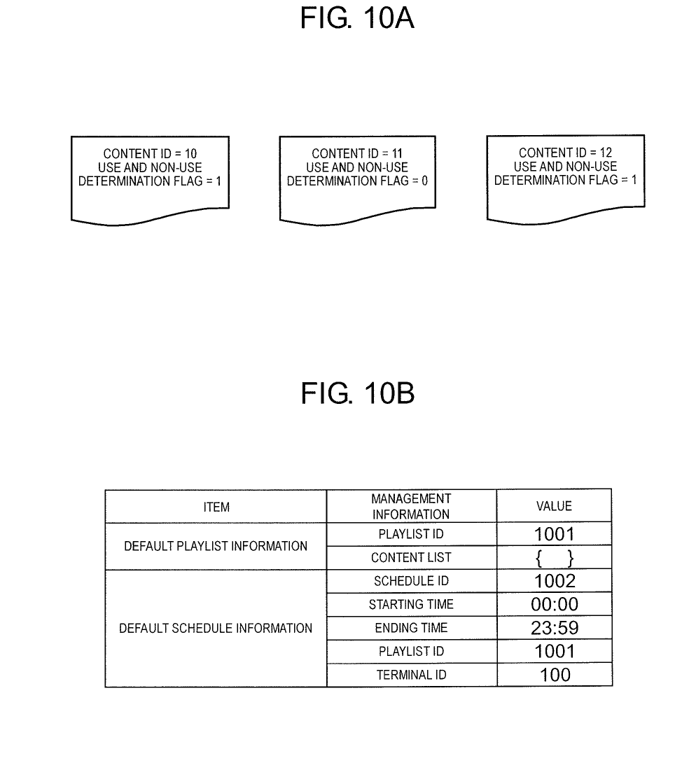

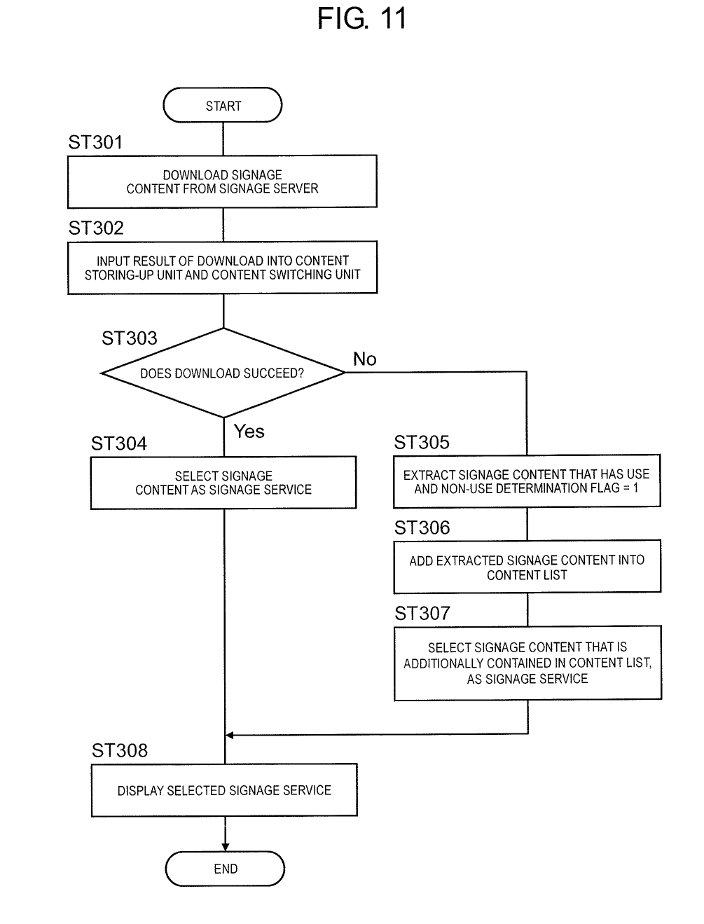

Next, signage terminal 5 according to a third embodiment of the present disclosure will be described with reference to FIGS. 10A, 10B, and 11. Signage terminal 5 according to the third embodiment is different from that according to the second embodiment in that the reproduction-completed signage content is used as the default content. In the third embodiment, it is assumed that matters that will be not particularly described below is the same as those in the first embodiment and the second embodiment, which are described above.

The reproduction-completed signage content is the signage content that is already reproduced in the past in signage terminal 5, and is stored up in content storage 32. Furthermore, content switching unit 41 retains the default playlist information and the default schedule information for reproducing the reproduction-completed signage content as the default content. FIGS. 10A and 10B are diagrams, each illustrating an example of the reproduction-completed signage content. FIG. 10A illustrates an example of the content data of the reproduction-completed signage content. FIG. 10B illustrates the default playlist information and the default schedule information that are the reproduction schedule.

In an example in FIG. 10A, three pieces of content data of the reproduction-completed signage content are present, and content ID's, “10,” “11,” and “12” are affixed to the pieces of signage content data, respectively. Furthermore, a flag (the use and non-use determination information) that defines whether or not the content data is used as the default content is affixed to each piece of content data. A use and non-use flag that is “1” indicates that content data is available for reproduction in a reproduction schedule other than the reproduction schedule (refer to FIG. 5B). That is, the use and non-use determination flag that is “1” means that the signage content can be used as the default content after the reproduction. The use and non-use flag that is “0” indicates that the signage content is available for reproduction in a reproduction schedule other than the reproduction schedule. That is, the use and non-use determination flag that is “0” means that the signage content cannot be used as the default content after the reproduction. In a case where the signage content is advertisement information such as a television CM, because in most cases, a reproduction limitation is imposed on the reproduction time for the content and the number of times that the content is reproduced, the use and non-use determination information may be set by referring to such reproduction limitation information.

The default playlist information and the default schedule information in FIG. 10B are the same as those (refer to FIG. 8B) in the second embodiment, which are described above, and thus descriptions thereof are omitted. A blank space is left in the content list of pieces of default playlist information in a default state, and the signage content, the use and non-use determination flag for which is “1” is additionally contained in the content list.

Next, a flow for processing by signage terminal 5 according to the third embodiment will be described with reference to a flow in FIG. 11.

ST301 to ST304 are the same as ST101 to ST104 according to the first embodiment, which are described above, and thus descriptions thereof are omitted. In Step ST305 that follows ST304, the signage content that has use and non-use determination flag=1 is extracted from the reproduction-completed signage content that is stored up in content storage 32. Subsequently, in Step ST306, the signage content that has the use and non-use determination flag=1, which is extracted from content storage 32, is additionally contained in the content list of pieces of default playlist information. In next Step ST307, content switching unit 41 not only passes the default playlist information and default service information to the signage service selector 42, but also instructs the signage service selector 42 to select the signage content that has the use and non-use determination flag =1, which is additionally contained in the content list, as the signage service. In Step ST308, the display processor 44 displays the signage service that is selected in the signage service selector 42.

With signage terminal 5 according to the third embodiment of the present disclosure, which is configured as described above, in the case where the download of the signage content from signage server 3 fails, because instead of the signage content of which the download fails, the reproduction-completed signage content that is stored up in content storage 32 is displayed as the substitute content, it is possible that the blackout in signage terminal 5 at the time of the failure of the download is avoided. Furthermore, the reproduction-completed signage content can be used as the default content, there is no need to store up the default content in advance in the content storage 32. Furthermore, because the signage content that is defined as being available for use as the default content is used as the default content, it is possible that only suitable signage content that is determined in advance is used as the substitute content. Accordingly, there is no concern that unsuitable signage content will be used as the default content.

### Fourth Embodiment

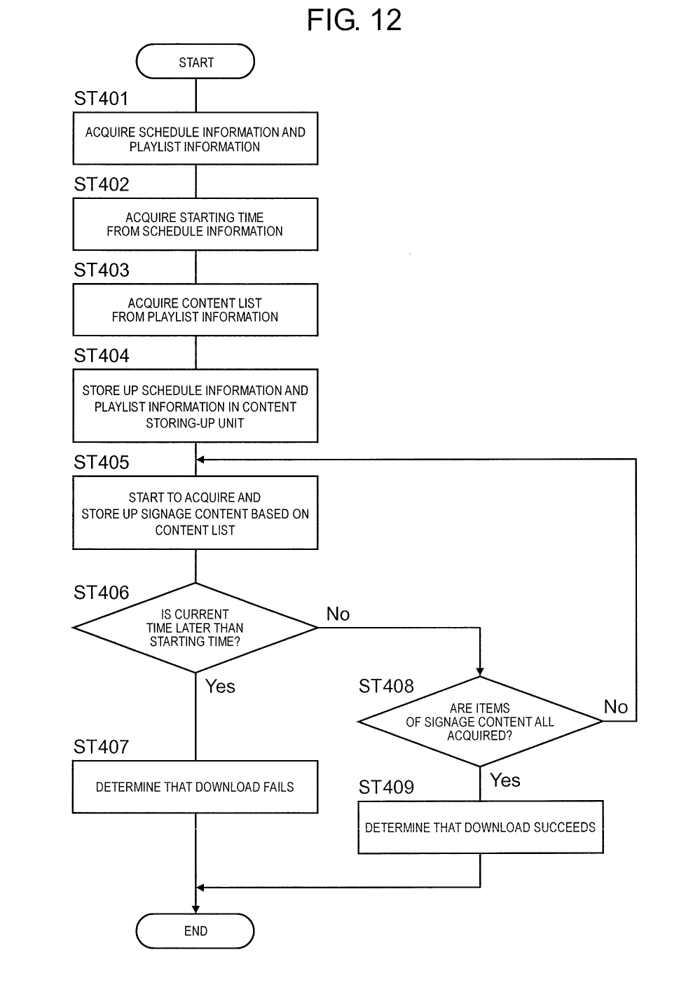

Next, signage terminal 5 according to a fourth embodiment of the present disclosure will be described with reference to FIG. 12. Signage terminal 5 according to the fourth embodiment is different from those according to the first embodiment to the third embodiment in that even in a case where the download delays, it can be determined that the download fails. In the fourth embodiment, it is assumed that matters that will be not particularly described below is the same as those in the first embodiment to the third embodiment, which are described above.

In signage terminal 5 according to the fourth embodiment, in a case where the download of the signage content from signage server 3 is not completed by the starting time (the reproduction starting time for the signage content) that is defined in the schedule information, it is determined that the download fails. A flow for processing that determines whether the download succeeds or fails in signage terminal 5 according to the fourth embodiment will be described below with reference to FIG. 12. The processing that determines whether the download succeeds or fails is performed by content switching unit 41 and receiver 31 that is controlled by content switching unit 41.

First, receiver 31 acquires the schedule information and the playlist information from signage server 3 (Step ST401). Subsequently, the starting time (the reproduction starting time for the signage content) is acquired from the schedule information (Step ST402). Next, the content list (a list of content ID's that are arranged in the order of reproduction) is acquired from the playlist information (Step ST403). In following Step ST404, the schedule information and the playlist information, which are received by receiver 31, are stored up in content storage 32. In nest Step ST405, based on the content ID that is defined in the content list, the signage content starts to be stored up (to be downloaded from signage server 3) and starts to be stored up in content storage 32.

Next, in Step ST406, it is determined whether or not a current time is later than the starting time (the reproduction starting time) that is acquired from the schedule information. In a case where it is determined that the current time is later than the starting time (Yes in Step ST406), proceeding to Step ST407 takes place. In a case where it is determined that the current time is not later than the starting time (No in Step ST406), proceeding to Step ST408 takes place.

In Step ST407, it is determined that the download fails. In Step ST408, based on the result of the download in receiver 31, it is determined whether or not items of signage content that are defined in the content list are all acquired. In a case where it is determined that the items of signage content that are defined in the content list are all acquired (Yes in Step ST408), proceeding to Step ST409 takes place. In a case where it is determined that the items of signage content are not all acquired (No in Step ST406), returning to Step ST405 takes place. In Step ST409, it is determined that the download succeeds.

In this manner, with signage terminal 5 according to a fourth embodiment of the present disclosure, in a case where the download of the signage content from signage server 3 is not completed by the starting time (the reproduction starting time) that is defined in the schedule information, that is, in a case where the download delays, it can be determined that the download fails. Accordingly, in a case where the download delays, the substitute content is displayed instead of the signage content of which the download delays, and thus it is possible that the blackout in signage terminal 5 is avoided.

The present disclosure is provided above based on the specific embodiments, but the embodiments are only examples, and the present disclosure is not limited by the embodiments. Furthermore, all the constituent elements of each of the signage terminal, the signage system, and the content reproduction method, which are described above, are not necessarily essential, and it is possible to make a suitable selection from among the all constituent elements at least within a range that does not depart from the scope of the present disclosure.

### INDUSTRIAL APPLICABILITY

The signage terminal, the signage system, and the content reproduction method according to the present disclosure are useful as a signage terminal, a signage system, and a content reproduction method, respectively, in all of which the blackout in the signage terminal is set to be avoided in a case where the download of the signage content from the signage server to the signage terminal fails or delays.

### REFERENCE MARKS IN THE DRAWINGS

1 SIGNAGE SYSTEM

2 CONTENT INPUT APPARATUS

3 SIGNAGE SERVER

4 LIVE SERVER

5 SIGNAGE TERMINAL

31 RECEIVER

32 CONTENT STORAGE

33 CONTENT DISPLAY UNIT

34 STATUS MANAGEMENT UNIT

35 TRANSMITTER

41 CONTENT SWITCHING UNIT

42 SIGNAGE SERVICE SELECTOR

43 SERVICE SELECTOR

44 DISPLAY PROCESSOR

1. A signage terminal that reproduces and displays signage content that is downloaded from a signage server, the terminal comprising:
a receiver that downloads the signage content from the signage server based on a prescribed download instruction;
a content storage that stores up the signage content which is downloaded in the receiver; and
a content display unit that determines whether the download of the signage content in the receiver succeeds or fails, and that reproduces and displays the signage content which is stored up in the content storage, according to a reproduction schedule for the signage content, in a case where it is determined that the download succeeds, and displays a substitute content which is determined in advance, instead of the signage content of which the download fails, in a case where it is determined that the download fails.

2. The signage terminal of claim 1,
wherein, in a case where the download is not completed by a reproduction starting time that is defined in the reproduction schedule, the content display unit determines that the download fails.

3. The signage terminal of claim 1,
wherein, the substitute content is an image that is provided from an image providing server that is determined in advance.

4. The signage terminal of claim 1,
wherein the substitute content is a default content that is stored up in advance in the content storage.

5. The signage terminal of claim 4,
wherein the default content is reproduction-completed signage content that is stored up in the content storage.

6. The signage terminal of claim 5,
wherein use and non-use determination information that defines whether or not the signage content is used as the default content is assigned to the signage content, and referring to the use and non-use determination information, the signage content that is defined as being available for use as the default content is used as the default content.

7. A signage system comprising:
the signage terminal according to claim 1; and
a signage server that download-delivers the signage content to the signage terminal.

8. A content reproduction method that reproduces and displays signage content that is downloaded from a signage server, in a signage terminal, the method comprising:
a reception step of downloading the signage content from the signage server, based on a prescribed download instruction;
a content storing-up step of storing up the signage content; and
a content display step of determining whether the download of the signage content in the reception step succeeds or fails, and of reproducing and displaying the signage content that is stored up in the content storing-up step, according to a reproduction schedule for the signage content, in a case where it is determined that the download succeeds, and displaying a substitute content which is determined in advance, instead of the signage content of which the download fails, in a case where it is determined that the download fails.
